(19) United States
(12) Patent Application Publication
(10) Pub. No.: US 2026/0055996 A1
(43) Pub. Date: Feb. 26, 2026

(54) ARMOR CONNECTOR

(71) Applicant: Defenshield, Inc., Palm Coast, FL (US)

(72) Inventor: William Collins White, Palm Coast, FL (US)

(73) Assignee: Defenshield, Inc., Palm Coast, FL (US)

(21) Appl. No.: 19/306,040

(22) Filed: Aug. 21, 2025

Related U.S. Application Data
(60) Provisional application No. 63/686,795, filed on Aug. 25, 2024.

(51) Int. Cl. F41H 5/24; F16B 5/02

(52) U.S. Cl. CPC F41H 5/24; F16B 5/02

(57) ABSTRACT

A ballistic armor connector comprises a first a first connector component comprising a first arm and a second arm, and a second connector component comprising a first arm and a second arm. The first arm comprised in the second connector component may be positioned opposite the first arm comprised in the first connector component and may form a first recess therebetween. The second arm comprised in the second connector component may be positioned opposite the second arm comprised in the first connector component and may form a second recess therebetween. A portion of a first armor panel may be positioned in the first recess and a portion of a second armor panel may be positioned in the second recess to form a ballistic armor barrier. A fastener is mechanically coupled with the first and second connector components and maintains the first and second connector components relative to each other.

### CROSS REFERENCE TO RELATED APPLICATIONS

This application claims the benefit of U.S. Provisional Ser. No. 63/686,795, filed Aug. 25, 2024, the contents of which are hereby incorporated by reference in their entirety.

### BACKGROUND

There is a need for barriers behind which persons can position themselves for protection from ballistics, explosions, and harmful projectiles. In traditionally hostile environments such as war zones, soldiers often dig fox holes or trenches, or utilize natural bunkers for protection. Unfortunately, the threat of harm from gunfire and explosions now exists in areas and settings that previously were considered to be safe from such life-threatening dangers. Residential and commercial areas have, unfortunately, become the setting for deadly gunfire and explosions. In these and other settings, natural barrier formations may not exist, and it is not practicable or suitable to utilize traditional means of protection such as trenches or fox holes.

### SUMMARY

Applicant discloses a ballistic armor connector which may be used in a ballistic armor assembly to provide protection from projectiles and explosions. The ballistic armor assembly may protect an area on a protected side of the assembly from projectiles and/or blast forces originating from an attack side of the assembly.

An example ballistic armor connector may comprise a first a first connector component that may comprise a first arm and a second arm. The ballistic armor connector may further comprise a second connector component also comprising a first arm and a second arm.

The first arm comprised in the second connector component may be positioned opposite the first arm comprised in the first connector component and may form a first recess therebetween. The second arm comprised in the second connector component may be positioned opposite the second arm comprised in the first connector component and may form a second recess therebetween.

The ballistic armor connector may further comprise a fastener mechanically coupled with the first connector component and the second connector component and may configured to maintain the first connector component relative to the second connector component.

The first connector component may further comprise a first base wherein the first arm comprised in the first connector component may extend from the first base and the second arm comprised in the first connector component may extend from the first base. The first arm comprised in the first connector component may extend at an acute angle relative to the second arm comprised in the first connector component. The second connector component may further comprise a second base, wherein the first arm comprised in the second connector component may extend from the second base and the second arm comprised in the second connector component may extend from the second base. The first arm comprised in the second connector component may extend at an acute angle relative to the second arm comprised in the second connector component.

The ballistic armor connector may be comprised in an assembly with ballistic armor. The assembly may comprise a first armor panel and a second armor panel. A portion of the first armor panel may be positioned in the first recess formed between the first arm comprised in the first connector component and the first arm comprised in the second connector component. The portion of the first armor panel may abut the first arm comprised in the first connector component and the first arm comprised in the second connector component. The first armor panel may form a frictional interface with the first arm comprised in the first connector component and with the first arm comprised in the second connector component and may be secured relative to the first connector component and the second connector component by the frictional force. A portion of the second armor panel may be positioned in the second recess formed between the second arm comprised in the first connector component and second arm comprised in the second connector component. The portion of the second armor panel may abut the second arm comprised in the first connector component and the second arm comprised in the second connector component. The second armor panel may form a frictional interface with the second arm comprised in the first connector component and with the second arm comprised in the second connector component and may be secured relative to the first connector component and the second connector component by the frictional force.

The fastener may comprise a bolt, e.g., carriage bolt, and a nut. The bolt may extend through a first aperture in the first connector component and through a second aperture in the second connector component. The nut may be secured to a portion of the bolt extending past the second aperture. The first aperture may be formed in the first base of the first connector component and the second aperture may be formed in the second base of the second aperture component.

The ballistic armor connector may further comprise a third armor panel. A first receptacle may be formed in the first arm comprised in the second connector component and a second receptacle may be formed in the second arm comprised in the second connector component. A first portion of the third armor panel may be received in the first receptacle and a second portion of the third armor panel may be received in the second receptacle. The first portion of the third armor panel may form a frictional interface with the first receptacle and the second portion of the armor panel may form a frictional interface with the second receptacle. The frictional interface may secure the third armor panel relative to the second connector component. The third armor panel may be positioned opposite the bolt extending through the second connector component and thereby protect the bolt and the nut secured thereto from tampering as well as from ballistics.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features are described below.

### BRIEF DESCRIPTION OF DRAWINGS

The following description of the illustrative embodiments may be better understood when read in conjunction with the appended drawings. It is understood that potential embodiments of the disclosed systems and methods are not limited to those depicted.

FIG. 1A depicts a front perspective view of an example armor connector assembly.

FIG. 1B depicts a rear perspective view of an example armor connector assembly.

FIG. 2 depicts a rear perspective view of an example armor connector assembly with armor panels received in the example armor connector assembly.

FIG. 3 depicts a sectional view of an example armor connector assembly.

FIG. 4A depicts a sectional view of an example armor connector assembly with armor panels received in the example armor connector assembly.

FIG. 4B depicts an enlarged isolated sectional view of a portion of the example armor connector assembly with armor panels received in the example armor connector assembly.

FIG. 5A depicts a perspective view of an example first connector component.

FIG. 5B depicts a sectional view of an example first connector component.

FIG. 5C depicts a view of a first side of an example first connector component.

FIG. 5D depicts a view of a second side of an example first connector component.

FIG. 6A depicts a perspective view of an example second connector component.

FIG. 6B depicts a sectional view of an example second connector component.

FIG. 6C depicts a view of a first side of an example second connector component.

FIG. 6D depicts a view of a second side of an example second connector component.

FIG. 7A depicts a front view of an example armor panel.

FIG. 7B depicts a side view of an example armor panel.

FIG. 8A depicts a perspective view of an example connector cap.

FIG. 8B depicts a top view of an example connector cap.

FIG. 8C depicts a side view of an example connector cap.

FIG. 8D depicts an isolated side view of an example connector cap.

FIG. 9 depicts a side view of an example bolt.

FIG. 10 depicts a side view of an example nut.

FIG. 11 depicts a perspective view of an example washer.

FIG. 12 depicts a perspective view of an example ballistic barrier formed using example ballistic armor connectors.

### DETAILED DESCRIPTION

Applicant discloses herein a ballistic armor connector which may be used in a ballistic armor assembly that provides protection from projectiles and explosions. The ballistic armor assembly may protect an area on a protected side of the assembly from projectiles and/or blast forces originating from an attack side of the assembly.

An example ballistic armor connector may comprise a first a first connector component comprising a first arm and a second arm, and a second connector component which also comprises a first arm and a second arm. The first arm comprised in the second connector component may be positioned opposite the first arm comprised in the first connector component and may form a first recess therebetween. The second arm comprised in the second connector component may be positioned opposite the second arm comprised in the first connector component and may form a second recess therebetween. A portion of a first armor panel may be positioned in the first recess and a portion of a second armor panel may be positioned in the second recess. A fastener may be mechanically coupled with the first connector component and the second connector component and may configured to maintain the first connector component relative to the second connector component.

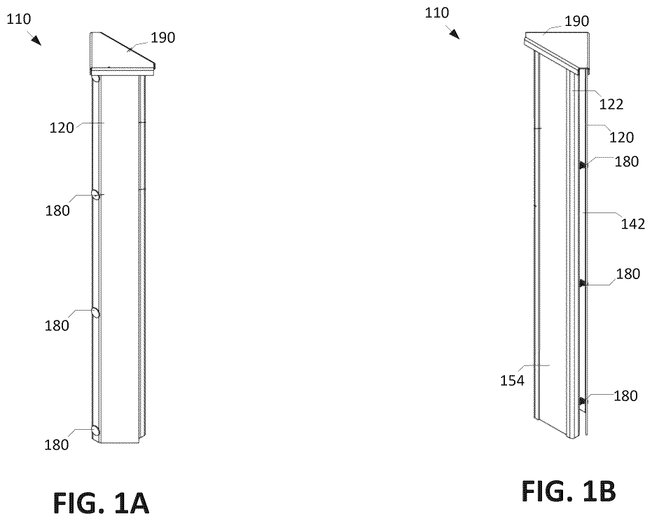

FIG. 1A depicts a front perspective view of an example armor connector 110. FIG. 1B depicts a rear perspective view of the example armor connector 110. The example armor connector 110 may comprise a first connector component 120 and a second connector component 122. A first recess and a second recess 142 may be formed between the first connector component 120 and the second connector component 122. A first armor panel may be received in the first recess and a second armor panel may be received in the second recess 142.

The second connector component may have a first receptacle formed therein and a second receptacle formed therein. A third armor panel 154 may be received in the first receptacle and the second receptacle.

One or more fasteners 180 may be mechanically coupled to the first connector component 120 and the second connector component 122 and may maintain the first connector component 120 relative to the second connector component 122. In an example, the fasteners 180 may extend through apertures formed in the first connector component 120 and second connector component 122. A fastener 180 may be any suitable device such as, for example, a bolt and washer.

An armor connector 110 may comprise a cap 190. The cap 190 may be positioned over an end of the assembly and thereby protect an interior space from elements and from tampering. The armor connector 110 comprising, for example, the first connector component 120, the second connector component, the third armor panel 154, fastener 180, and cap 190 may be made from ballistic resistant material such as, for example, steel or similar ballistic resistant metal.

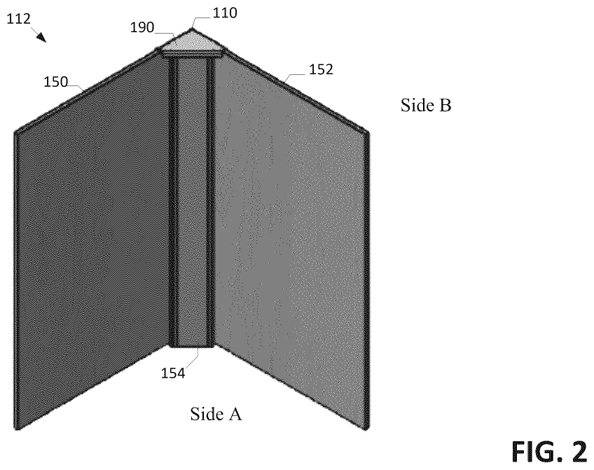

FIG. 2 depicts a rear perspective view of the armor connector 110 with armor panels received in the armor connector 110 to form a barrier assembly. As shown, a first portion of a first armor panel 150 is received in a first recess created in the in the armor connector assembly 110. A remaining portion of the first armor panel 150 extends out of the recess and away from the armor connector 110. A first portion of a second armor panel 152 is received in a second recess formed by the armor connector 110. A remaining portion of the second armor panel 152 extends out of the recess and away from the armor connector 110. The armor connector 110 with armor panels 150 and 152 received therein forms a barrier assembly 112. The armor connector 110 and the armor panels 150 and 152 may be positioned on the ground and may extend from the ground to any suitable height. In an example, the armor connector 110 and the armor panels 150 and 152 may extend to a height sufficient to obscure a person standing behind the barrier assembly 112. Persons positioned on a first side of the barrier assembly 112 may be protected from projectiles and blasts originating from the second side of the barrier assembly 112. For example, and referring to FIG. 2, a person situated on Side A of the barrier assembly 112, may be protected from projectiles and blasts originating from Side B of the barrier assembly 112. Likewise, a person situated on Side B of the barrier assembly 112 may be protected from projectiles and blasts originating from Side A of the barrier assembly 112. As shown, the barrier assembly 112 provides overlapping components, eliminates gaps, and provides a continuous barrier. The barrier provided by the assembly may extend from the surface on which the barrier is resting to the top of the armor panels. The armor panels may be any height suitable for the desired application.

Armor panels 150 and 152 may be formed from any suitable material including, for example armor, steel, armor glass, wood, and/or composite. The armor panels 150 and 152 may be covered to simulate a variety of textures and colors. It will be appreciated that while armor panels 150 and 152 are shown as comprising a continuous material body, in examples, the armor panels 150 and 152 may comprise windows and/or selective openings such, for example, transaction ports, gun ports, and/or doors.

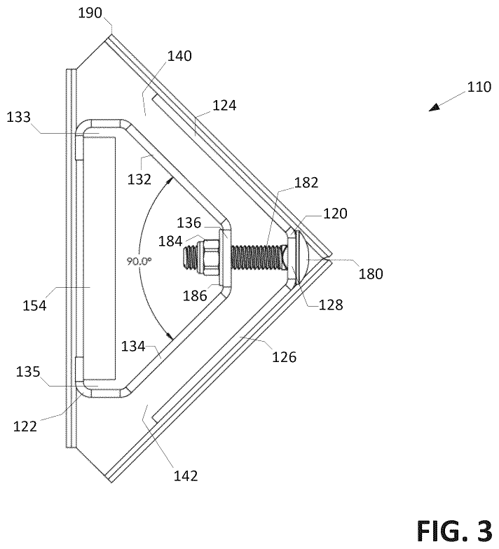

FIG. 3 depicts a sectional view of the example armor connector 110 depicted in FIGS. 1A and 1B. As shown, the armor connector 110 may comprise a first connector component 120 and a second connector component 122. The first connector component 120 may comprise a base 128 with a first arm 124 extending from the base 128 and a second arm 126 extending from the base 128. The first arm 124 and the second arm 126 form an angle, e.g., acute angle, therebetween. It will be appreciated that the first arm 124 and the second arm 126 may be formed relative to each other so as to produce an angle therebetween different than that depicted and suitable for any desired implementation.

The second connector component 122 may comprise a base 136 with a first arm 132 extending from the base 136 and a second arm 134 extending from the base 136. The first arm 132 and the second arm 134 form an angle, e.g., an acute angle, therebetween. It will be appreciated that the first arm 132 and the second arm 134 may be formed relative to each other so as to produce an angle therebetween different than that depicted and suitable for any desired implementation.

A first recess 140 may be formed between the first arm 124 of the first connector component 120 and the first arm 132 of the second connector component 122. The first recess 140 may be sized so as to accept a portion of an armor panel therein. A second recess 142 may be formed between the second arm 126 of the first connector component 120 and the second arm 134 of the second connector component 122. The second recess 142 may be sized so as to accept a portion of an armor panel therein.

One or more fasteners 180 may be mechanically coupled to the first connector component 120 and the second connector component 122 and may be configured to maintain the first connector component 120 relative to the second connector component 122. In an example, the one or more fasteners 180 may comprise a bolt 182, a nut 184, and a washer 186. The bolt 186 may extend through an aperture or hole in the base 128 of the first connector component 120 and an aperture or hole in the base 136 of the second connector component 122.

The second connector component 122 may comprise a first receptacle 133 and a second receptacle 135. The first receptacle 133 may be formed in the first arm 132 of the second connector component 122 and the second receptacle 135 may be formed in the second arm 134 of the second connector component 122. The receptacles 133 and 135 may be formed, for example, by bends in the first arm 132 and the second arm 134, respectively.

A first portion of a third armor panel 154 may be received in the first receptacle 133 and a second portion of the third armor panel 154 may be received in the second receptacle 135. The third armor panel 154 may be composed of any suitable material such as, for example, a ballistic resistant material. The first portion of the third armor panel 164 may form a frictional interface with the first receptacle 133. The second portion of the third armor panel 164 may form a frictional interface with the second receptacle 135. The frictional interfaces operate to maintain the position of the third armor panel 164 relative to the second connector component 122. The third armor panel is positioned opposite the bolt 182 and nut 184 and thereby provides protection for the bolt 182 and nut 184 from tampering and ballistics. As shown in FIG. 1B, the third armor panel 154 may extend the length of the armor connector assembly 110.

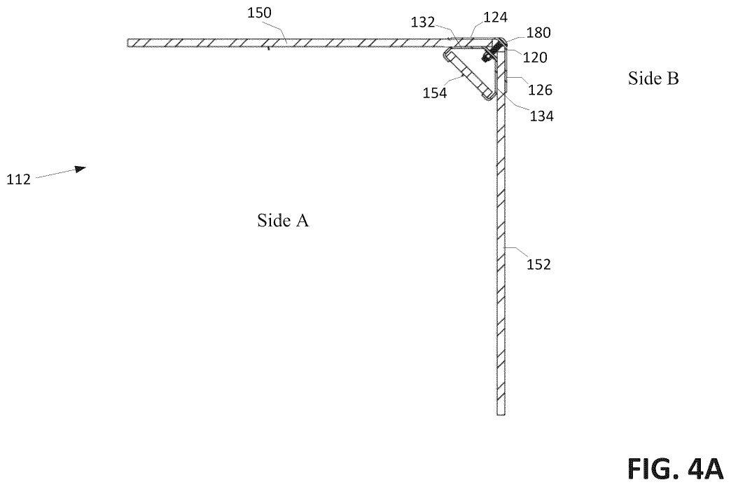

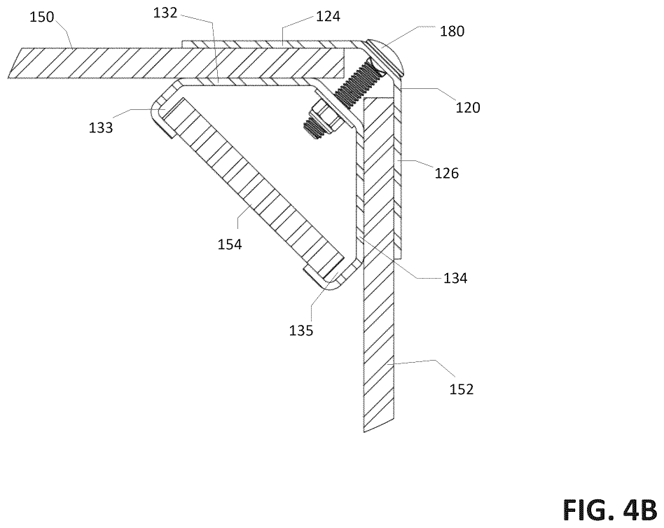

FIG. 4A depicts a sectional view of the armor connector 110 with armor panels 150 and 152 received in the armor connector assembly 110 to form a barrier assembly 112. FIG. 4B depicts an enlarged isolated sectional view of a portion of the armor connector 110 with armor panels 150 and 152 received therein. As shown, in the recess formed between the first arm 124 of the first connector component 120 and the first arm 132 of the second connector component 122, a portion of the first armor panel 150 is positioned. The first armor panel 150 overlaps the first arm 124 of the first connector component 120 and the first arm 132 of the second connector component 122 and thereby provides an uninterrupted front for repelling ballistics. The first arm 124 of the first connector component 120 may abut and press against the first armor panel 150. The first arm 132 of the second component 122 may abut and press against the first armor panel 150. A frictional interface may be formed between the first armor panel 150 and the first arm 124 of the first connector component 120 and the first arm 132 of the second connector component 122.

In the recess formed between the second arm 126 of the first connector component 120 and the second arm 134 of the second connector component 122, a portion of the second armor panel 152 is positioned. The second armor panel 152 overlaps the second arm 126 of the first connector component 120 and the second arm 134 of the second connector component 122 and thereby provides an uninterrupted front for repelling ballistics. The second arm 126 of the first connector component 120 may abut and press against the second armor panel 152. The second arm 134 of the second component 122 may abut and press against the second armor panel 152. A frictional interface may be formed between the second armor panel 152 and the second arm 126 of the first connector component 120 and the second arm 134 of the second connector component 122.

Bolt 182 extends through an aperture in the first connector component 120 and an aperture in the second connector component 122. A washer 186 is placed the portion of the bolt 182 that extends beyond the second connector component 122. A nut 184 is threaded onto threads formed on bolt 180. As the nut 184 is tightened, pressure is applied to the second connector component 122 and the second connector component 122 is pressed toward the first connector component 120. The movement of the second connector component 122 towards first connector component 120 results in pressure being applied by the second connector component 122 and the first connector component 120 on the first armor panel 150 and the second armor panel 152. The pressure applied by the first connector component 120 and the second connector component 122 on the first armor panel 150 and the second armor panel 152 secures the panels 150 and 152 in place relative to the armor connector 110. Armor panel 150 and armor panel 152 may be held secure by the clamping pressure between connector components 120 and 122.

The first armor panel 150 and the second armor panel 152 extend at an angle (e.g., acute) relative to each other. The angle between first armor panel 150 and second armor panel 152 may be determined by the angle of the arms extending in the first connector component 120 and the second armor component 122. The angle between the first armor panel 150 and the second armor panel 152 may be different than that depicted and may be adapted to any suitable implementation.

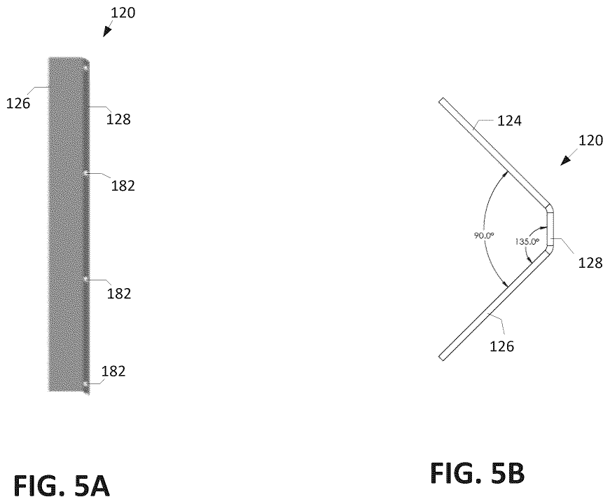

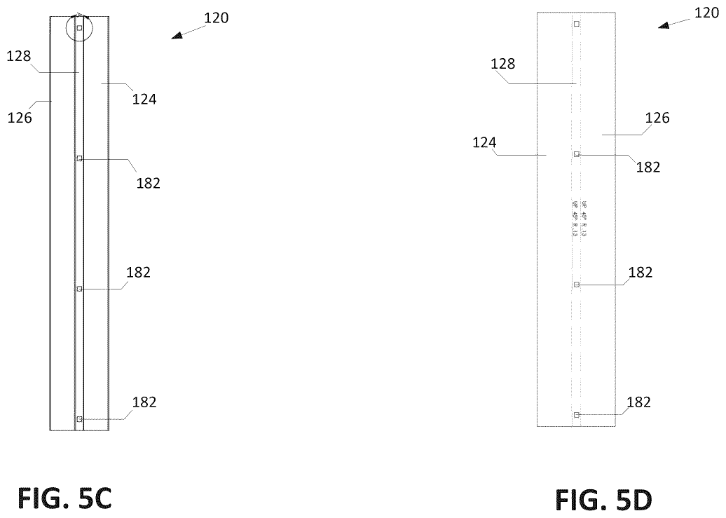

FIG. 5A depicts a perspective view of an example first connector component 120. FIG. 5B depicts a sectional view of the first connector component 120. FIG. 5C depicts a view of a first side of the first connector component 120. FIG. 5D depicts a view of a second side of the first connector component 120. The first connector component 120 may be formed of a ballistic resistant material such as, for example, steel. The first connector component 120 may comprise a base 128, a first arm 124 extending from the base 128 and a second arm 126 extending from the base 128. The first arm 124 and the second arm 128 may extend at an angle relative to each other. The size of the angle may vary depending on the intended application. The base 128 may have apertures or holes 182 formed therein adapted to receive therethrough fasteners 180 which may be bolts 182. The first connector component 120 may be situated lengthwise extending from the ground or supporting surface and may extend to any suitable height for the desired implementation. For example, the first connector component 120 may be sufficiently long to be comprised in a ballistic barrier assembly 112 behind which a person may stand.

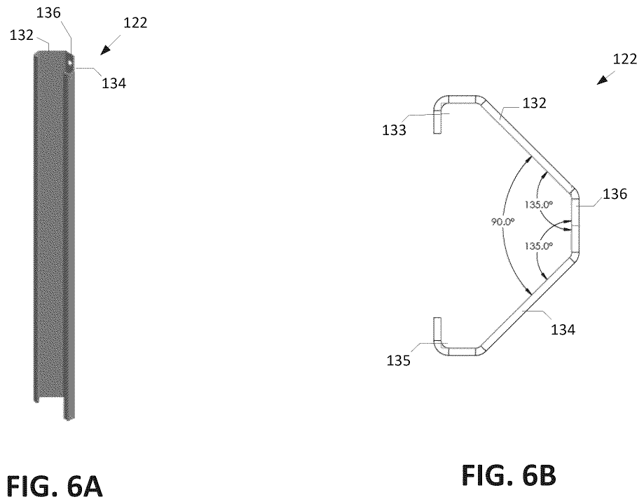

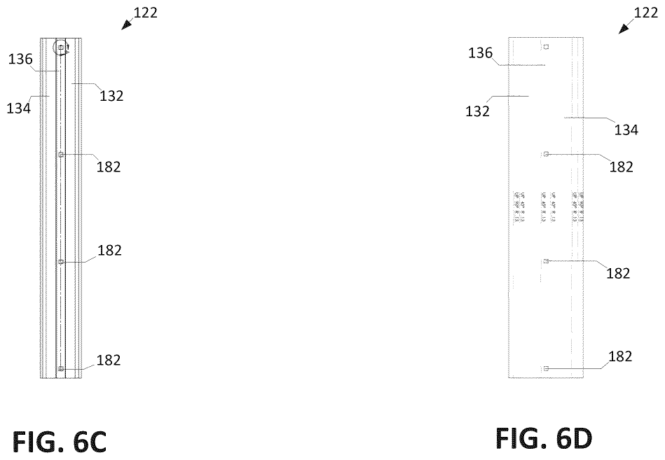

FIG. 6A depicts a perspective view of an example second connector component 122. FIG. 6B depicts a sectional view of the second connector component 122. FIG. 6C depicts a view of a first side of the second connector component 122. FIG. 6D depicts a view of a second side of the second connector component 122. The second connector component 122 may be formed of a ballistic resistant material such as, for example, steel. The second connector component 122 may comprise a base 136, a first arm 132 extending from the base 136 and a second arm 134 extending from the base 136. The first arm 132 and the second arm 134 may extend at an angle relative to each other. The size of the angle may vary depending on the intended application. A first receptacle 133 may be formed in the first arm 132 and a second receptacle 135 may be formed in the second arm 134. The first receptacle 133 may be formed by a bend in the first arm 132. The second receptacle 135 may be formed by a bend in the second arm 134. The first receptacle 133 and the second receptacle 135 may be positioned opposite each other and spaced and sized to receive the third armor panel 154 therein. The base 136 may have apertures or holes 182 formed therein adapted to receive therethrough fasteners 180 which may be bolts 182. The second connector component 122 may be situated lengthwise extending from the ground or supporting surface and may extend to any suitable height for the desired implementation. For example, the second connector component 122 may be sufficiently long to be comprised in a ballistic barrier assembly 112 behind which a person may stand.

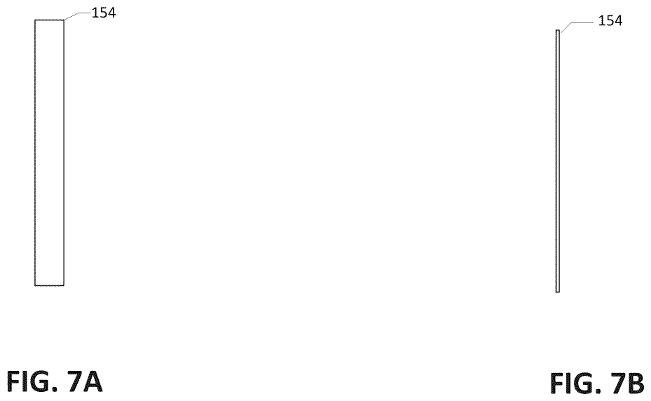

FIG. 7A depicts a front view of an example third armor panel 154. FIG. 7b depicts a side view of the third armor panel 154. The third armor panel 154 may be formed of a ballistic resistant material such as, for example, steel. The second connector component 122 may be situated lengthwise extending from the ground or supporting surface and may extend to any suitable height for the desired implementation. For example, the second connector component 122 may be sufficiently long to be comprised in a ballistic barrier assembly 112 behind which a person may stand.

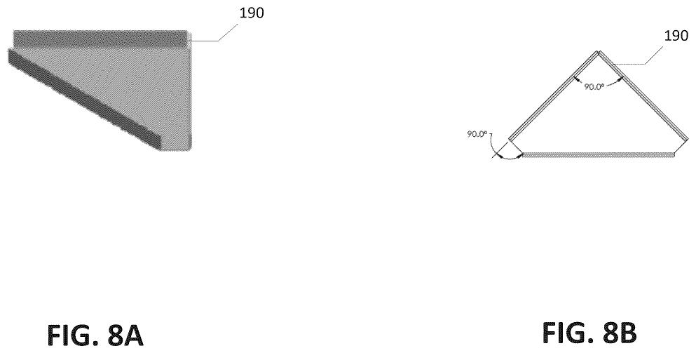

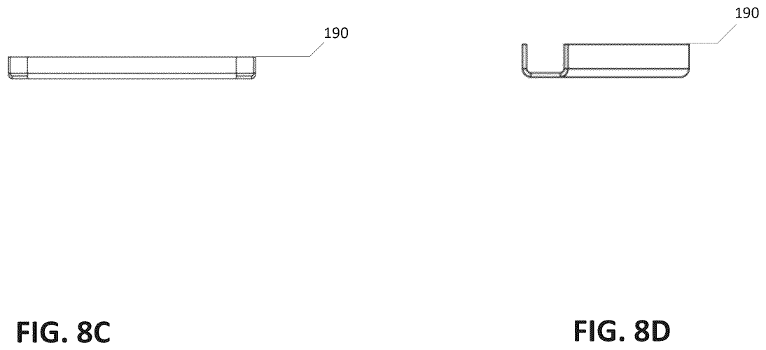

FIG. 8A depicts a perspective view of an example connector cap 190. FIG. 8B depicts a top view of the connector cap 190. FIG. 8C depicts a side view of the connector cap 190. FIG. 8D depicts an isolated partial side view of the connector cap 190. As shown, the connector cap 190 is formed to generally correspond to the outline of the combined first connector component 120, second connector component 122, and the third armor panel 154. In an example, the connector cap 190 may have a generally triangular shape. As shown, the connector cap 190 may have a flat surface with a lip extending at an angle relative to the flat surface. The flat surface may be seated on top of an end of the combined first connector component 120, second connector component 122, and third armor panel 154 as depicted in FIGS. 1A, 1B, and 2. The lip comprised in the connector cap 190 may abut the corresponding one of the first connector component 120, second connector component 122, or third armor panel 154 and thereby maintain the connector cap 190 in place relative to the combination. The connector cap 190 closes the interior of the armor connector assembly 110 and thereby repels the elements and prevents tampering. The connector cap 190 may be made of any suitable material such as, for example, steel.

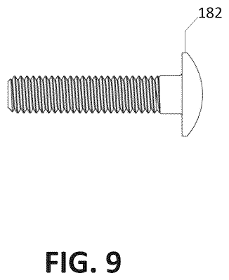

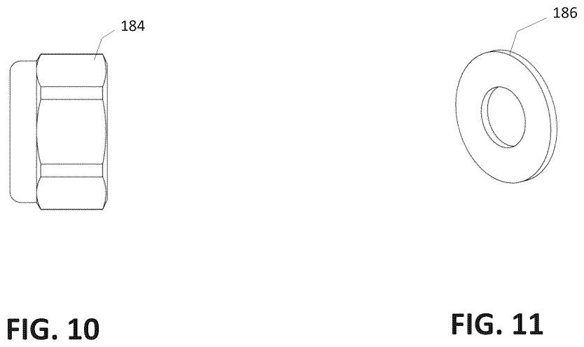

The fastener 180 may be any device suitable to connect the first connector component 120 and the second connector component 122 as described herein. In an example, the fastener 180 may comprise the bolt 182, washer 186, and nut 184. FIG. 9 depicts a side view of the example bolt 186. The bolt 186 may be any that is suitable including, for example, a carriage bolt. FIG. 10 depicts a side view of the example nut. FIG. 11 depicts a perspective view of an example washer.

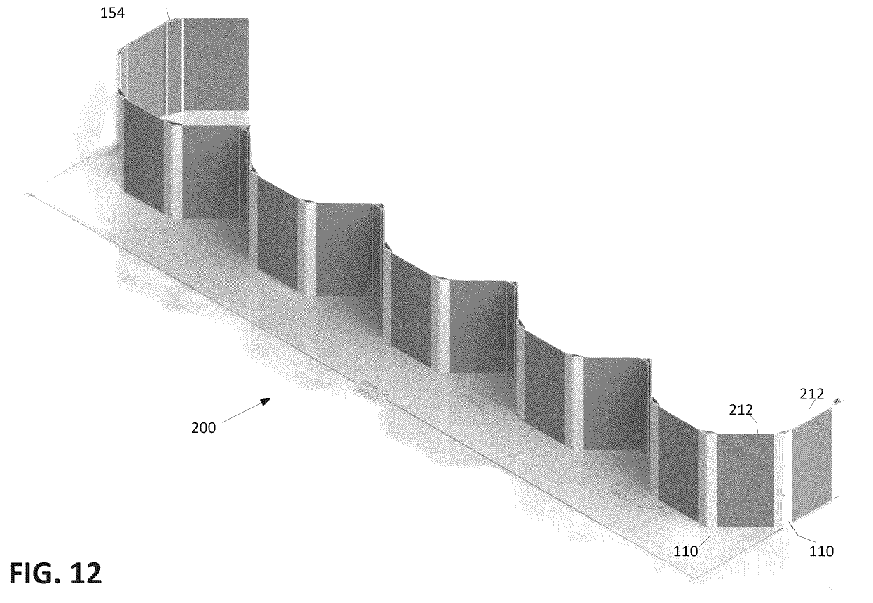

FIG. 12 depicts a perspective view of an example ballistic barrier 200 formed by connecting in series multiple armor panels 212 using multiple armor connectors 110. As shown, the angles at which the armor panels 212 are connected may vary as a function of the varying angles implemented by the armor connectors 110. For example, varied angles (e.g., +60 degrees to −60 degrees) may be formed in a ballistic barrier 200. Armor connectors 110 may be used to form inside (acute) and outside (obtuse) angles. The ability to vary the angles at which the armor panels 212 are connected allows for creating ballistic barriers 200 with varied shapes and configurations. Likewise, the length of the barrier 200 can be extended by connecting additional armor panels 212 using additional armor connectors 110. A ballistic barrier 200 may be situated on any supporting surface such as the ground or floor and may be used indoors and/or outdoors.

Accordingly, Applicant has disclosed a ballistic armor connector which may be used in a ballistic armor assembly that provides protection from projectiles and explosions. An example ballistic armor connector may comprise a first a first connector component comprising a first arm and a second arm, and a second connector component which also comprises a first arm and a second arm. The first arm comprised in the second connector component may be positioned opposite the first arm comprised in the first connector component and may form a first recess therebetween. The second arm comprised in the second connector component may be positioned opposite the second arm comprised in the first connector component and may form a second recess therebetween. A portion of a first armor panel may be positioned in the first recess and a portion of a second armor panel may be positioned in the second recess to form a ballistic armor barrier. A fastener may be mechanically coupled with the first connector component and the second connector component and may configured to maintain the first connector component relative to the second connector component.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some or all of the elements in the list.

The foregoing description is provided for the purpose of explanation and is not to be construed as limiting the potential embodiments. While the embodiments have been described with reference to preferred embodiments or preferred methods, it is understood that the words which have been used herein are words of description and illustration, rather than words of limitation. Furthermore, although the invention has been described herein with reference to particular structure, methods, and embodiments, the potential embodiments are not intended to be limited to the particulars disclosed herein, as the potential embodiments extend to all structures, methods and uses that are within the scope of the appended claims. Further, to the degree that advantages have been described that flow from the structure and methods; the potential embodiments are not limited to structure and methods that encompass any or all of these advantages. Those skilled in the relevant art, having the benefit of the teachings of this specification, may effect numerous modifications to the potential embodiments as described herein, and changes can be made without departing from the scope and spirit of the potential embodiments as defined by the appended claims. Furthermore, any features of one described embodiment can be applicable to the other embodiments described herein.

What is claimed is:

1. An assembly, comprising:
a first connector component, the first connector component comprising a first arm and a second arm;
a second connector component, the second connector component comprising a first arm and a second arm, the first arm comprised in the second connector component positioned opposite the first arm comprised in the first connector component and forming a first recess therebetween, the second arm comprised in the second connector component positioned opposite the second arm comprised in the first connector component and forming a second recess therebetween;
a fastener mechanically coupled with the first connector component and the second connector component and configured to maintain the first connector component relative to the second connector component.

2. The assembly of claim 1,
wherein the first connector component further comprises a first base, the first arm comprised in the first connector component extending from the first base and the second arm comprised in the first connector component extending from the first base, first arm comprised in the first connector component extending at an acute angle relative to the second arm comprised in the first connector component; and
wherein the second connector component further comprises a second base, the first arm comprised in the second connector component extending from the second base and the second arm comprised in the second connector component extending from the second base, first arm comprised in the second connector component extending at an acute angle relative to the second arm comprised in the second connector component.

3. The assembly of claim 2, further comprising:
a first armor panel, a portion of the first armor panel positioned in the first recess and abutting the first arm comprised in the first connector component and the first arm comprised in the second connector component; and
a second armor panel, a portion of the second armor panel positioned in the second recess and abutting the second arm comprised in the first connector component and the second arm comprised in the second connector component.

4. The assembly of claim 3,
wherein the fastener comprises a bolt and a nut, the bolt extending through a first aperture in the first connector component and through a second aperture in the second connector component, the nut secured to a portion of the bolt extending past the second aperture.

5. The assembly of claim 4, wherein the bolt is a carriage bolt.

6. The assembly of claim 4,
wherein the first aperture is formed in the first base and the second aperture is formed in the second base.

7. The assembly of claim 6,
wherein a first receptacle is formed in the first arm comprised in the second connector component and a second receptacle is formed in the second arm comprised in the second connector component.

8. The assembly of claim 7, wherein the assembly further comprises a third armor panel, a first portion of the third armor panel received in the first receptacle and a second portion of the third armor panel received in the second receptacle, the third armor panel positioned opposite the bolt.

9. The assembly of claim 8, wherein the first portion of the third armor panel forms a frictional interface with the first receptacle and the second portion of the third armor panel forms a frictional interface with the second receptacle.

10. The assembly of claim 9,
wherein the first armor panel forms a frictional interface with the first arm comprised in the first connector component and the first arm comprised in the second connector component; and
wherein the second armor panel forms a frictional interface with the second arm comprised in the second connector component and the second arm comprised in the second connector component.
